(19) United States
(12) Patent Application Publication
(10) Pub. No.: US 2023/0152230 A1
(43) Pub. Date: May 18, 2023

(54) SIMULTANEOUS DETECTION OF LASER EMISSION AND FLUORESCENCE

(71) Applicant: THE REGENTS OF THE UNIVERSITY OF MICHIGAN, Ann Arbor, MI (US)

(72) Inventors: Xudong FAN, Ann Arbor, MI (US); Qiushu CHEN, San Bruno, CA (US); Yunlu SUN, Ann Arbor, MI (US)

(73) Assignee: THE REGENTS OF THE UNIVERSITY OF MICHIGAN, Ann Arbor, MI (US)

(21) Appl. No.: 17/919,671

(22) PCT Filed: Apr. 30, 2021
(86) PCT No.: PCT/US2021/030112

§ 371 Date: Oct. 18, 2022

Related U.S. Application Data
(60) Provisional application No. 63/017,899, filed on Apr. 30, 2020.

(51) Int. Cl. G01N 21/64

(52) U.S. Cl. CPC G01N 21/6458; G01N 21/6428; G01N 2021/6439; G01N 2021/6421

(57) ABSTRACT

The present disclosure provides an imaging system. The imaging system may include a laser cavity that is configured to receive a biological sample, where the biological sample is treated with a dye; an excitation light source that is configured to direct energy at the laser cavity so as to cause an emission from the biological sample, where the emission includes a laser emission at a first spectral band and a fluorescence emission at a second spectral band; a first detector that is configured to measure the laser emission generated by the biological sample; a second detector that is configured to measure the fluorescence emission generated by the biological sample; a splitter that is configured to direct the laser emission to the first detector and the fluorescence emission to the second detector; and a controller interfaced with the excitation light source, the first detector, and the second detector.

### CROSS-REFERENCE TO RELATED APPLICATION

This application claims the benefit of U.S. Provisional Application No. 63/017,899, filed on Apr. 30, 2020. The disclosure of the above application is incorporated herein by reference in its entirety.

### GOVERNMENT CLAUSE

This invention was made with government support under ECCS1607250 awarded by the National Science Foundation. The government has certain rights in the invention.

### FIELD

The present disclosure relates to method and systems for imaging tissue samples, for example, by detecting laser and fluorescence emissions simultaneously.

### BACKGROUND

Both fluorescence and laser emission can be used for the detection of biomolecular interactions and imaging. For example, in fluorescence-based detection, biomaterials, such as biomolecules (e.g., DNA and proteins), cells, and tissues, are placed in a fluidic chamber or on a solid substrate. The fluorophores (such as, dyes and quantum dots) co-existing with the biomaterials are excited to produce fluorescence. The characteristics of fluorescence, such as intensity, polarization, lifetime, and the like, are detected so as to reflect the underlying biological processes and disease status.

In laser emission-based detection, biomaterials, such as biomolecules (e.g., DNA and proteins), cells, and tissues, are placed inside a laser cavity. Laser emission is realized when the fluorophores (such as, dyes and quantum dots) are excited above their lasing threshold. The characteristics of the laser emission (such as, lasing threshold, laser efficiency, and polarization) are detected so as to reflect the underlying biological processes or disease status. Laser emission and fluorescence are measured separately as a result of certain imaging constraints. For example, one imaging constraint is that mirrors used to define a laser cavity configured to measure laser emissions in the green spectrum blocks the green fluorescence, preventing simultaneous measurement of both laser emission and fluorescence. As such, typically for fluorescence emission detection, a top mirror forming the laser cavity is removed.

This section provides background information related to the present disclosure which is not necessarily prior art.

### SUMMARY

This section provides a general summary of the disclosure, and is not a comprehensive disclosure of its full scope or all of its features.

In various aspects, the present disclosure provides an imaging system. The imaging system may include a laser cavity that is configured to receive a biological sample, where the biological sample is treated with a dye; an excitation light source that is configured to direct energy at the laser cavity so as to cause an emission from the biological sample, where the emission includes a laser emission at a first spectral band and a fluorescence emission at a second spectral band; a first detector that is configured to measure the laser emission generated by the biological sample; a second detector that is configured to measure the fluorescence emission generated by the biological sample; a splitter that is configured to direct the laser emission to the first detector and the fluorescence emission to the second detector; and a controller interfaced with the excitation light source, the first detector, and the second detector.

In one aspect, the laser cavity may be defined by a first mirror and a second mirror, and the biological sample may be disposed between the first mirror and the second mirror.

In one aspect, the first mirror may be arranged parallel to the second mirror.

In one aspect, a reflectivity of the first mirror may be greater than a first threshold so as to detect the laser emission, and a transmission of the first mirror may be above a second threshold so as to detect the fluorescence emission.

In one aspect, the splitter may be a dichroic mirror that is configured to separate the fluorescence emission and the laser emission included in the emission from the biological sample.

In one aspect, the first spectral band may be between about 524 nm and about 570 nm, and the second spectral band may be greater than about 590 nm.

In one aspect, the excitation light source may be configured to perform at least one of single-photon excitation and multi-photon excitation.

In one aspect, the imaging system may further include a motorized stage. The laser cavity may be disposed on the motorized stage.

In one aspect, the controller may further interface with the motorized stage. The controller may be configured to adjust a position of the laser cavity relative to the excitation light source using the motorized stage.

In one aspect, the controller may be configured to align a first location of the laser cavity with the excitation light source, and subsequently, to align a second location of the laser cavity with the excitation light source.

In one aspect, the splitter may be a first splitter, and the imaging system may further include at least one of a beam expansion lens set, a mirror, a mirror scanning system, a scanning lens set, a second splitter, and an objective lens that is configured to direct the energy at the laser cavity.

In one aspect, the splitter may be a first splitter, and the imaging system may further include at least one of a second splitter, a tube lens, and an objective lends that is configured to direct the emission to the first splitter.

In various aspects, the present disclosure provides an imaging system. The imaging system may include a motorized stage; a laser cavity disposed on the motorized stage and configured to receive a biological sample, the biological sample is treated with a dye; an excitation light source configured to direct energy at the laser cavity causing an emission from the biological sample, where the emission includes a laser emission at a first spectral band and the excitation light source is configured to cause at least one of single-photon excitation and multi-photon excitation; a first detector that is configured to measure the laser emission generated by the biological sample; and a controller interfaced with the excitation light source, the first detector, and the motorized stage. The controller may be configured to adjust a position of the motorized stage based on a predetermined location within the laser cavity, and direct the excitation light source to direct energy to the predetermined location within the laser cavity to perform single-photon excitation and multi-photon excitation.

In one aspect, the imaging system may further include a second detector that is configured to measure a fluorescence emission at a second spectral band generated by the biological sample, where the emission includes the fluorescence emission, and the controller is further interfaced with the second detector.

In one aspect, the imaging system may further include a beam splitter that is configured to receive the emission and direct the laser emission to the first detector and direct the fluorescence emission to the second detector.

In one aspect, the predetermined location within the laser cavity may include an x location, a y location, and a z location.

In various aspects, the present disclosure provides and imaging system. The imaging system may include a motorized stage; a laser cavity disposed on the motorized stage and configured to receive a biological sample, where the laser cavity is defined by a first mirror and a second mirror and the biological sample is disposed between the first mirror and the second mirror, and the biological sample is treated with a dye; an excitation light source that is configured to direct energy at the laser cavity causing an emission from the biological sample, where the emission includes a laser emission at a first spectral band and a fluorescence emission at a second spectral band, and the excitation light source is configured to cause at least one of single-photon excitation and multi-photon excitation; a first detector that is configured to measure the laser emission generated by the biological sample; a second detector that is configured to measure the fluorescence emission generated by the biological sample; a beam splitter that is configured to direct the laser emission to the first detector and the fluorescence emission to the second detector; and a controller interfaced with the excitation light source, the first detector, the second detector, and the motorized stage.

In one aspect, a reflectivity of the first mirror may be greater than a first threshold so as to detect the laser emission, and a transmission of the first mirror may be above a second threshold so as to detect the fluorescence emission.

In one aspect, the beam splitter may be a dichroic mirror that is configured to separate the fluorescence emission and the laser emission included in the emission from the biological sample.

In one aspect, the controller may be configured to adjust a position of the motorized stage based on a predetermined location within the laser cavity; and direct the excitation light source to direct energy to the predetermined location within the laser cavity to perform single-photon excitation and multi-photon excitation.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of a simultaneous detection imaging system.

FIG. 2 is a diagram of a side view of a laser cavity used in a simultaneous detection imaging system, such as the simultaneous detection imaging system as illustrated in FIG. 1.

FIG. 3 is graphical illustration of example transmission curves of laser cavity mirrors within a laser cavity in a simultaneous detection imaging system, such as the laser cavity as illustrated in FIG. 2 and/or the simultaneous detection imaging system as illustrated in FIG. 1.

FIG. 4A is a graphical illustration of a fluorescence spectrum of an example dye.

FIG. 4B is a graphical illustration of a lasing spectrum of the example dye.

FIG. 5A is an image of a normal lung tissue captured during fluorescence-based detection.

FIG. 5B is an image of the normal lung tissue captured during lasing emission-based detection.

FIG. 5C is a heat map of the normal lung tissue captured using lasing emission-based detection, which illustrates the density of lasing spots.

FIG. 5D is an image of the normal lung tissue prepared using hematoxylin and eosin (“H&E”) staining.

FIG. 6A is an image of a cancerous lung tissue captured during fluorescence-based detection.

FIG. 6B is an image of the cancerous lung tissue captured during lasing emission-based detection.

FIG. 6C is a heat map of the cancerous lung tissue captured using lasing emission-based detection, which illustrates the density of lasing spots.

FIG. 6D is an image of the cancerous lung tissue prepared using hematoxylin and eosin (“H&E”) staining.

FIG. 7A is a graphical illustration shown in logarithmic scale of pump thresholds for various levels of cell differentiations in a cancerous lung tissue.

FIG. 7B is a graphical illustration shown in linear scale of pump thresholds for various levels of cell differentiations in a cancerous lung tissue.

FIG. 8A is a diagram of a side view of a laser cavity during regular single-photo excitation of tissue treated with dye.

FIG. 8B is a diagram of a side view of a laser cavity during multiphoton excitation of tissue treated with dye.

Corresponding reference numerals indicate corresponding parts throughout the several views of the drawings.

### DETAILED DESCRIPTION

Example embodiments will now be described more fully with reference to the accompanying drawings.

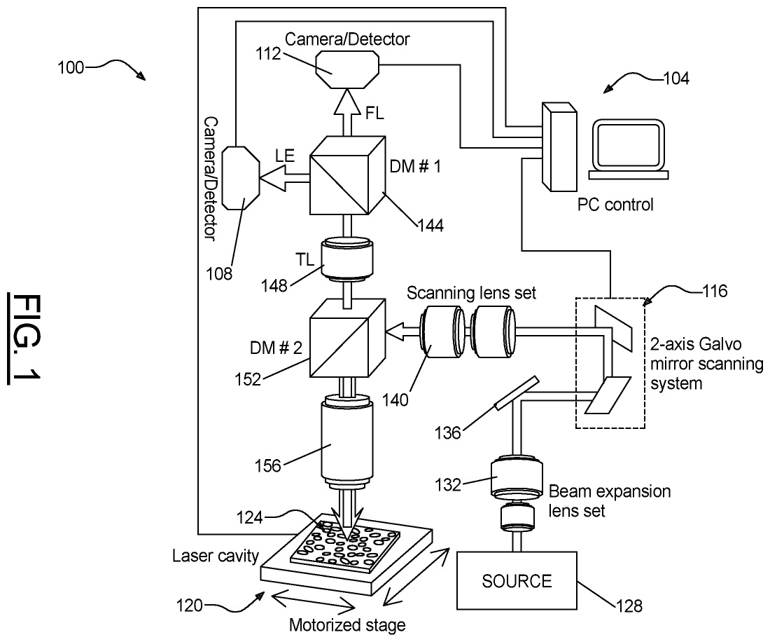

FIG. 1 is a schematic illustration of a simultaneous detection imaging system 100. The simultaneous detection imaging system 100 is configured to simultaneously perform fluorescence-based detection and lasing emission-based detection. The simultaneous detection imaging system 100 generally includes a controller 104, a first detector 108, a second detector 112, a mirror scanning system 116, a motorized stage 120, a laser cavity 124, an excitation light source 128, a beam expansion lens set 132, a mirror 136, a scanning lens set 140, a first beam splitter 144, a tube lens 148, a second beam splitter 152, and an objective lens 156.

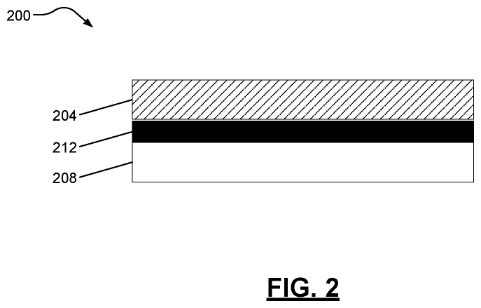

The laser cavity 124 is configured to hold a tissue sample. In some example embodiment, such as described in further detail in FIG. 2, the laser cavity 124 may include a first reflection surface and a second reflection surface and the tissue sample may be located or sandwiched between the first reflection surface and the second reflection surface. In each instance, the laser cavity 124 may be is located on the motorized stage 120. The motorized stage may be configured to move the tissue sample relative to the system 100 so to improve testing opportunities. In each instance, the excitation light source 128 is configured to illuminate a fluorophore in the tissue sample. For example, the excitation light source 128 may be configured to generate a pulsed laser, so as to interrogate a tissue or biological sample located in the laser cavity 124. The pulsed laser generated by the excitation source 128 may be directed toward the laser cavity 124 by the beam expansion lens set 132, the mirror 136, the mirror scanning system 116, the scanning lens set 140, the second beam splitter 152, and/or the objective lens 156. The skilled artisan will recognize that, in various instances, other types of light sources may be similarly used in placed of the excitation light source 128.

Prior to placement within the laser cavity 124, the tissue sample may be treated with a dye (such as, YO-PRO® or fluorescein isothiocyanate (FITC)) so as to generate fluorescence and laser emissions in desired color wavelengths. The fluorophore (i.e., dye molecules) of the treated tissue absorb the pulsed laser and reflect an emission back through the objective lens 156 that is pass through the second beam splitter 152 in a direction toward the first beam splitter 144. The second beam splitter 152 directs the emission to the first beam splitter 144 (and in turn to the first and second detectors 108 and 112) due to the change in wavelength of the emission (e.g., Stokes shift).

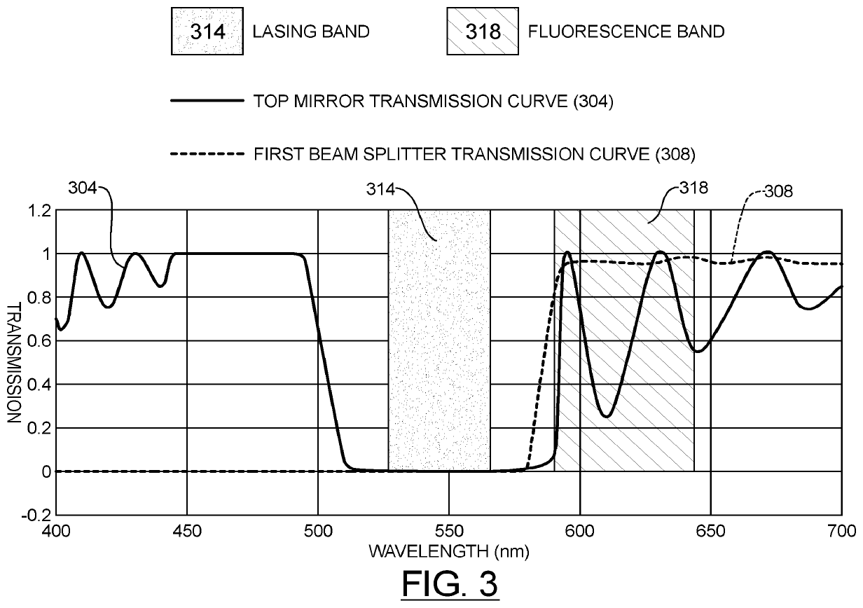

The emission traverses the tube lens 148 to reach the first beam splitter 144. The first beam splitter 144 separates the emission into a laser emission and a fluorescence emission. The laser emission may be directed to the first detector 108. The fluorescence emission may be directed to the second detector 112. Because the lasing band and the fluorescence band are within separate wavelengths (as shown in FIG. 3), the first beam splitter 144 can separate the two emissions to separately detect and image those emissions. The first beam splitter 144 and the second beam splitter 152 may include dichroic mirrors. The skilled artisan will recognize, however, that other types of beam splitters may be similarly used. The first detector 108 is configured to receive the laser emission from the emission beam reflected from the tissue sample that is being imaged. The first detector 108 provides the detected laser emission information to the controller 104. The second detector 112 is configured to receive the fluorescence emission from the emission beam reflected from the tissue that is being imaged. More specifically, the second detector 112 measures the fluorescence emission from the fluorophore (e.g., dye molecule) with which the tissue sample was treated. The second detector 112 provides the detected fluorescence information to the controller 104. The first detector 108 and the second detector 112 may both be cameras, or other imagers. The skilled artisan will recognize, however, that other types of detectors may be similarly used, including, for example, an avalanche photodiode, a spectrometer, or an avalanche photodiode and a spectrometer, and that the first detector 108 may be the same or different from the second detector 112.

The controller 104 may be a computer or a mobile computing device. In an example embodiment, the controller 104 may be separately connected to a computer or computing device. The controller 104 may be implemented, for example, as a microcontroller. The skilled artisan will recognize that the logic for the control of the simultaneous detection imaging system 100 by the controller 104 may be implemented in hardware logic, software logic, or a combination of hardware and software logic. In this regard, the controller 104 can be or can include any of a digital signal processor (DSP), microprocessor, microcontroller, or other programmable device, which are programmed with software implementing the above-described methods. It should be understood that alternatively the controller 104 is or includes other logic devices, such as a Field Programmable Gate Array (FPGA), a complex programmable logic device (CPLD), or application specific integrated circuit (ASIC). When it is stated that the controller 104 performs a function or is configured to perform a function, it should be understood that the controller 104 is configured to do so with appropriate logic (such as, in software, logic devices, or a combination thereof). As described in further detail below, the controller 104 can be implemented in a variety of subsystems configured to adjust the position of the motorized stage 120 so as to direct the pulse laser at different locations within the laser cavity 124.

In an example embodiment, the first detector 108 and the second detector 112 may be cameras that capture images of the laser emission and fluorescence emission, respectively, of the tissue sample. The images can be displayed on a user interface of the controller 104 or user interface of a computing device operably connected to the controller 104. The motorized stage 120 can be controlled by the controller 104 to be translated or moved.

As discussed above, the first beam splitter 144 is configured to separate the laser emission and the fluorescence emission from the emission generated from the tissue sample. Additional information describing the setup of a similar imaging device, which detects only the laser emission, is described in International Publication No. WO 2018/125925, the disclosure of which is hereby incorporated by reference in its entirety. In each instance, as discussed above, the tissue is treated with a dye (such as, YO-PRO® or fluorescein isothiocyanate (FITC), which are within the range of a first wavelength (e.g., about 500 nm to about 550 nm) and depict a first color (e.g., green). Since the two surfaces (mirrors) of the laser cavity 124 are configured to block the first wavelengths, fluorescence emissions cannot be recovered using a traditional imaging configurations and methods. However, because the mirrors of the laser cavity 124 have a tail in a second wavelength (e.g., red wavelength), the fluorescence emission can be identified, detected, and separated at the same time as the laser emission. In some example embodiments, the fluorescence and laser emissions can be measured consecutively instead of simultaneously.

In other words, the simultaneous detection imaging system 100 enables the acquisition of fluorescence and laser emission from the same tissue sample, and also, from the same type of fluorophore or dye staining the sample. Usually, the fluorescence spectrum of a fluorophore is broad. For example, dyes such as YO-PRO® and fluorescein isothiocyanate (FITC) have a spectral band of about 50 nm. In contrast, the laser emissions from those fluorophores usually have a linewidth less than about 1 nm. The lasing lines are also confined within a narrow spectral range (for example, about 10 nm). The large spectral difference between fluorescence and laser emissions (as shown in FIG. 3) allows the configuration of the laser cavity and the simultaneous detection imaging system 100 to spectrally separate the fluorescence and laser emissions by using the first beam splitter 144 to separate and direct the emissions to the respective detectors 108, 112.

Simultaneous acquisition of fluorescence and laser emissions provides complementary information obtained by fluorescence and laser emissions, which in turn provides better understanding of biological processes and disease status represented in the tissue sample. In an example embodiment, the controller 104 generates two separate images, one for the fluorescence emission and one for the laser emission. Additionally or alternatively, the laser emission can be superimposed on the fluorescence emission to produce a single image.

FIG. 2 is an side-view illustration of a laser cavity 200, as included in a simultaneous detection imaging system, such as the simultaneous detection imaging system 100 illustrated in FIG. 1. As illustrated, the laser cavity 200 includes a top or first mirror 204 and a bottom or second mirror 208. A sample 212, such as a tissue sample, is disposed between the first mirror 204 and the second mirror 208. In an example embodiment, the laser cavity 200 represents a Fabry-Perot assembly.

FIG. 3 is a graphical illustration of example transmission curves for laser cavity mirrors within a simultaneous detection imaging system, such as the laser cavity 200 as illustrated in FIG. 2 and the simultaneous detection imaging system 100 illustrated in FIG. 1. As illustrated, the x-axis in FIG. 3 represents wavelength (nm), and the y-axis represents transmission (%). An exemplary transmission curve of the first mirror 204 is shown by a first curve 304. An exemplary transmission curve of the first beam splitter 144 is shown by a second curve 308. The fluorophore (i.e., dye molecules) can be excited through the first mirror 204 at a spectral window that has a high transmission (for example, about 475 nm). The laser emission from the fluorophore (i.e., dye molecules) can be achieved within the lasing band 314 (e.g., between about 525 nm and about 570 nm) that has a low mirror transmission (for example, high mirror reflectivity). Within this lasing band 314, the laser emission can transmit through the first mirror 204, while the fluorescence within this band is blocked.

However, the fluorescence outside the low transmission band (i.e., laser bead) 314 (for example, the wavelength above about 590 nm) can be transmit through the first mirror 204. The first beam splitter 144 is used to separate the laser emission that is within the lasing band 314 and the fluorescence emission that is in the fluorescence band 318 (e.g., above about 590 nm), and directs the emissions to different cameras/detectors (e.g., the first detector 108 and second detector 112 as illustrated in FIG. 1).

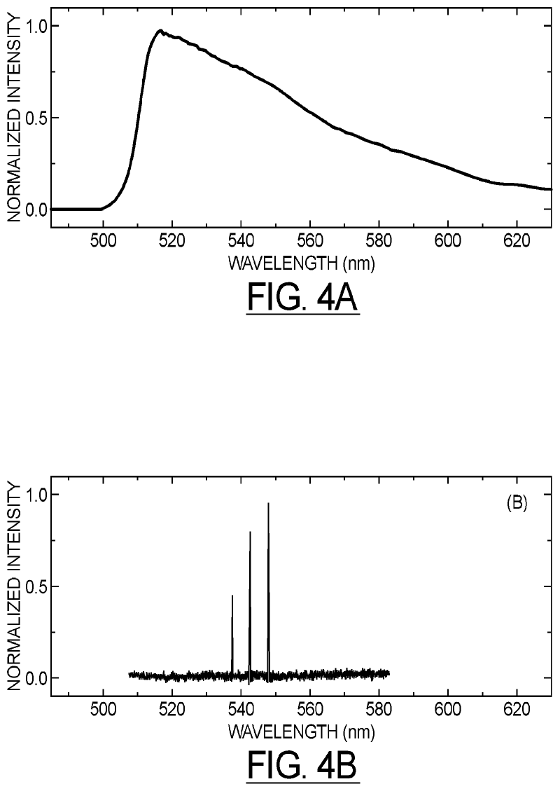

FIG. 4A is a graphical illustration of a fluorescence spectrum of an example dye (e.g., YO-PRO®), where the x-axis represents wavelengths (nm), and the y-axis represents normalized intensity. As illustrated in FIG. 4A, the full-width-at-half-maximum (“FWHM”) of the fluorescence is about 50 nm. FIG. 4B is a graphical illustration of a lasing spectrum of the example dye (e.g., YO-PRO®), where the x-axis represents wavelengths (nm), and the y-axis represents normalized intensity. As illustrated in FIG. 4B, the laser emission band is about 10 nm, and the full-width-at-half-maximum (“FWHM”) of each lasing line is less than about 1 nm.

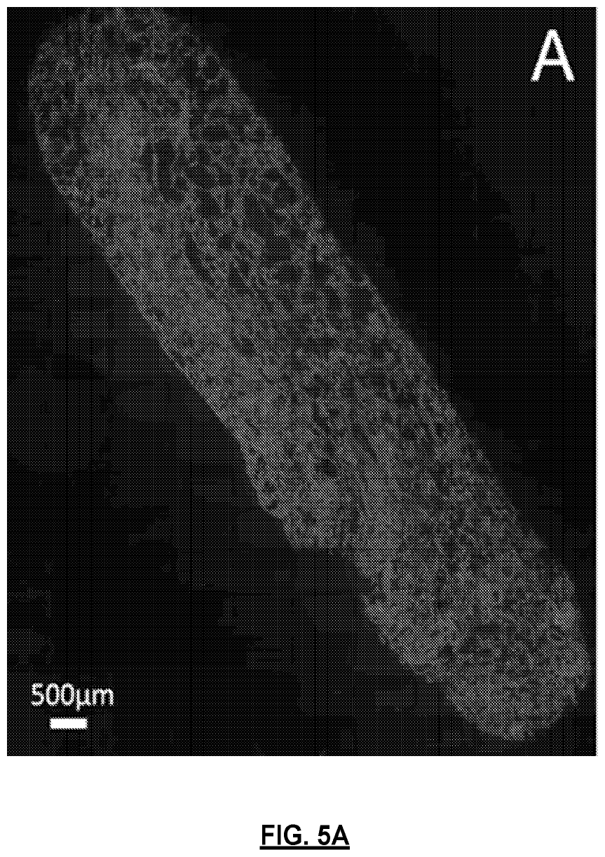

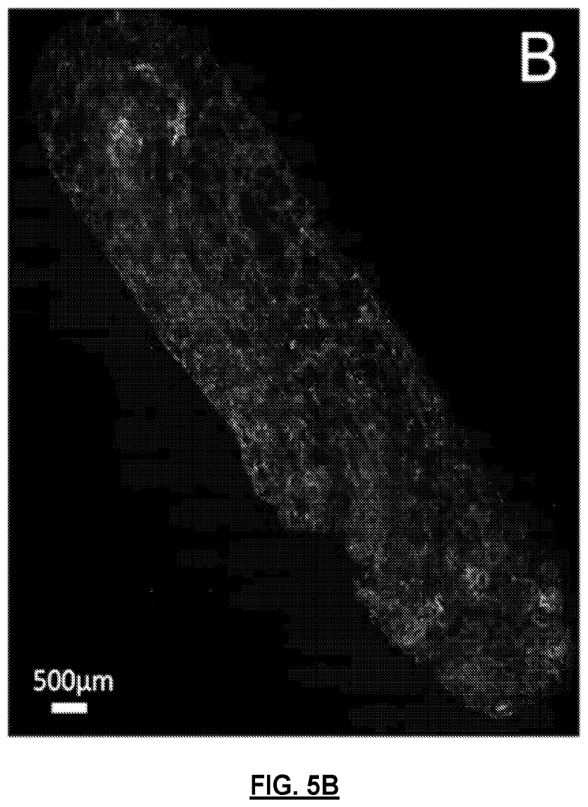

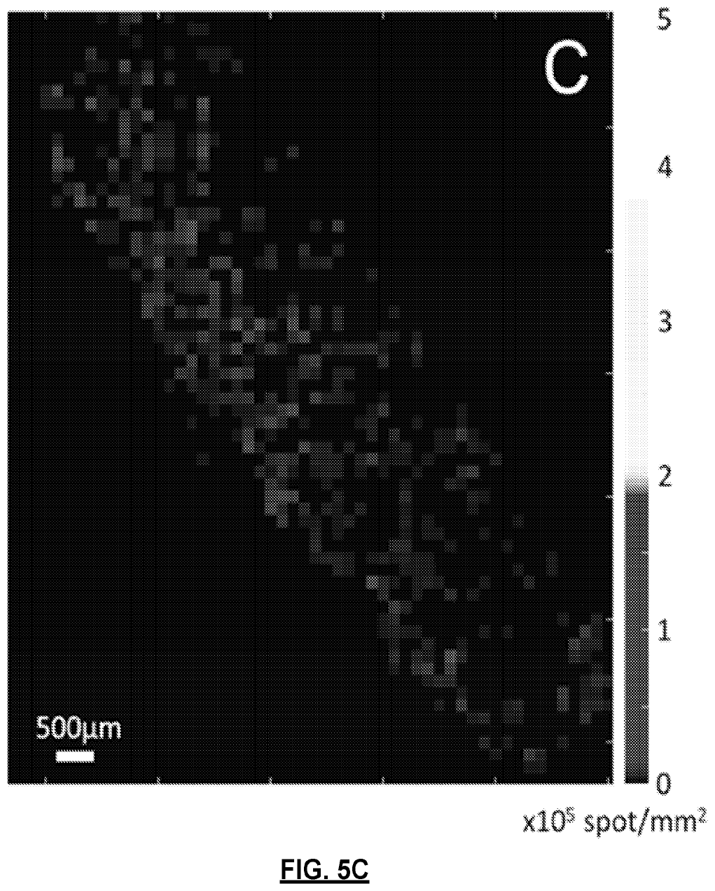

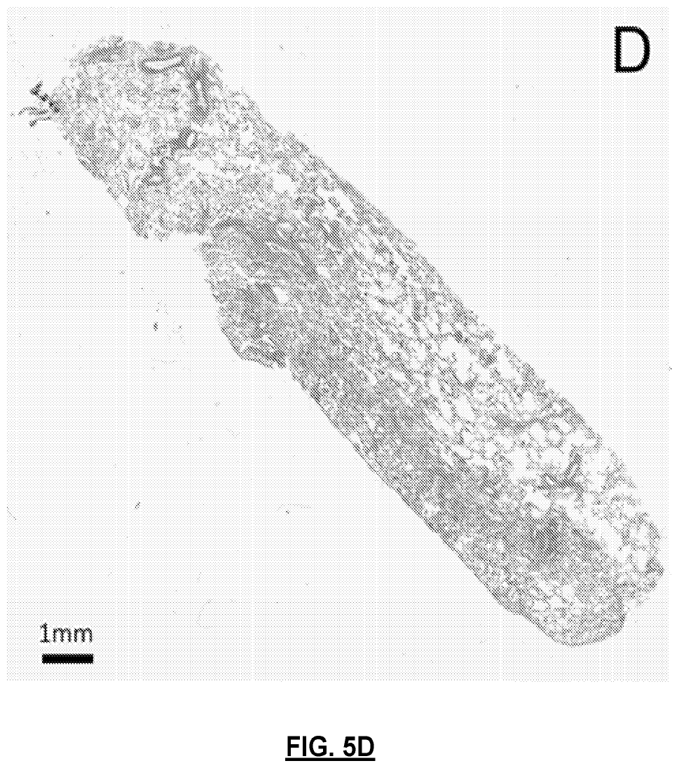

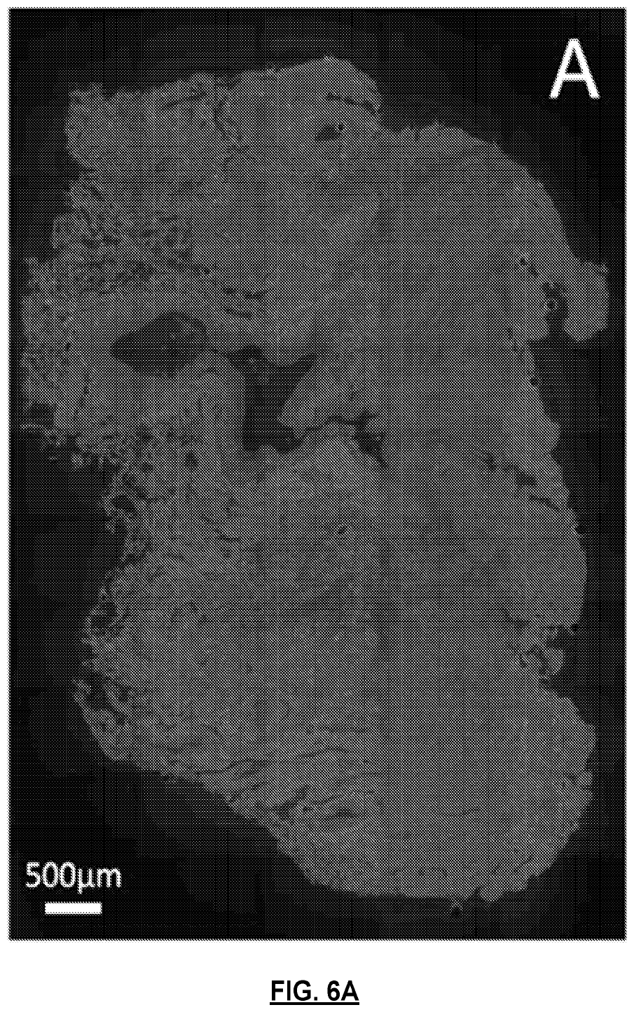

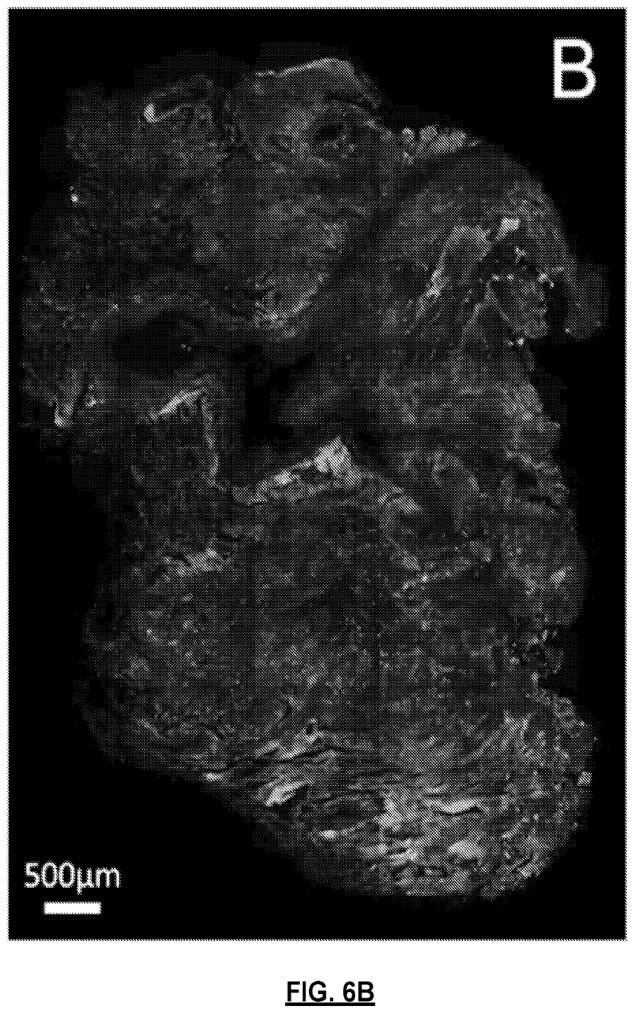

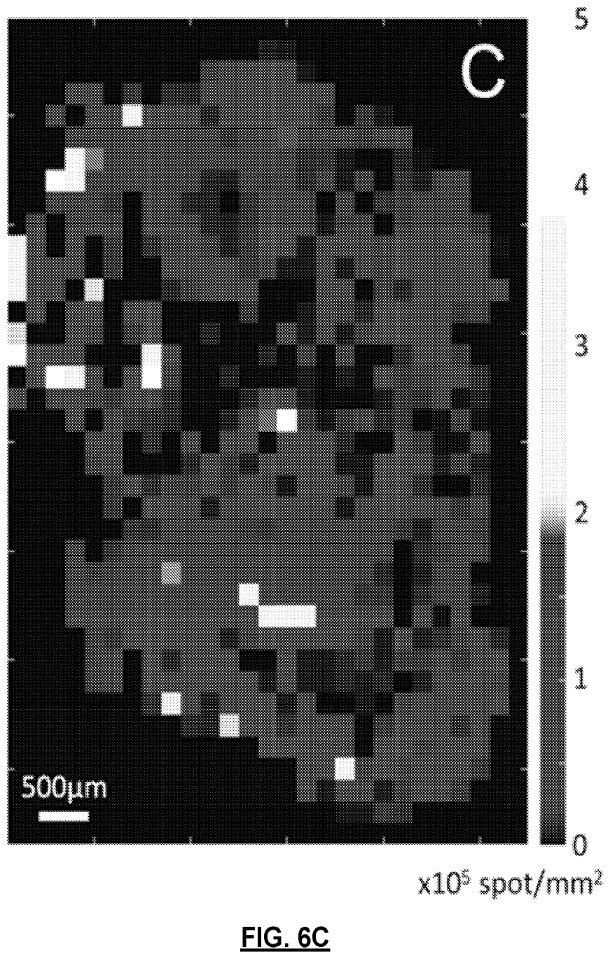

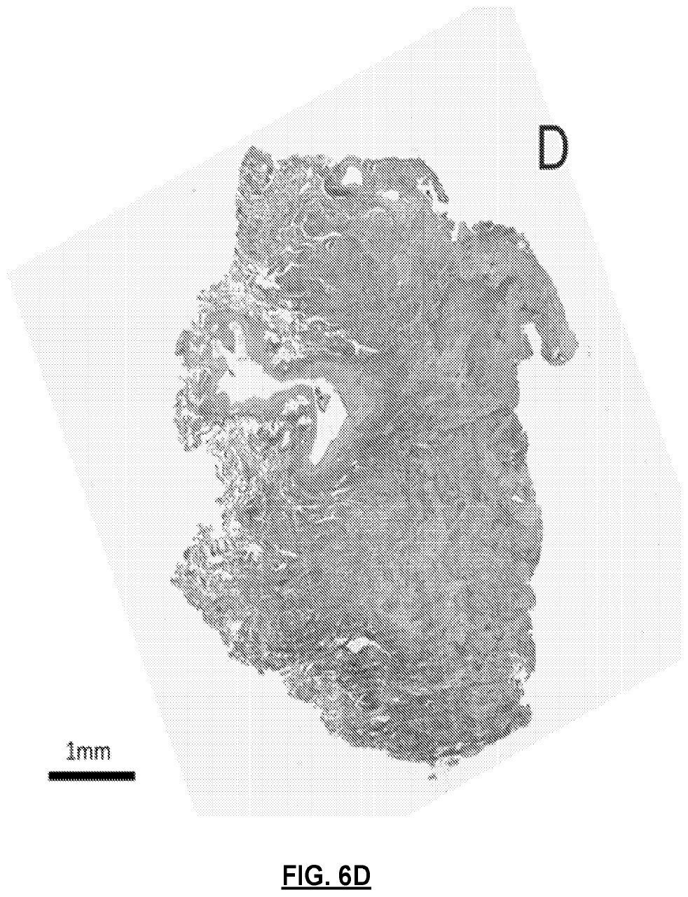

FIG. 5A is an image of a normal lung tissue captured using fluorescence-based detection. The detected fluorescence emission of the normal tissue sample can compared to a detected fluorescent emission of a tissue sample in a disease state (e.g., cancerous lung tissue) to identify differences between normal state and disease state tissues. For example, FIG. 6A is an image of a cancerous lung tissue captured during fluorescence-based detection.

FIG. 5B is an image of the normal lung tissue captured using lasing emission-based detection. The detected laser emission (i.e., LEM image) of the normal tissue sample can be compared to a detected laser emission (i.e., LEM image) of a tissue sample in a disease state (e.g., cancerous lung tissue) to identify differences between normal state and disease state tissues. For example, FIG. 6B is an image of the cancerous lung tissue captured during lasing emission-based detection.

FIG. 5C is a heat map of the normal lung tissue captured using lasing emission-based detection. The heat map of the normal tissue sample can be compared to a heat map of a tissue sample in a disease sate (e.g., cancerous lung tissue) to identify differences between normal state and disease state tissues. For example, FIG. 6C is a heat map of the cancerous lung tissue captured using lasing emission-based detection, which illustrates the density of lasing spots.

FIG. 5D is an image of the normal lung tissue prepared using hematoxylin and eosin (“H&E”) staining. The hematoxylin and eosin image (i.e., H&E image) of the normal tissue sample can be compared to the hematoxylin and eosin image (i.e., H&E image) of a disease state (e.g., cancerous lung tissue) to identify differences between normal state and disease state tissues. For example, FIG. 6D is an image of the cancerous lung tissue prepared using hematoxylin and eosin (“H&E”) staining.

The image of the normal lung tissue captured using fluorescence-based detection, as illustrated in FIG. 5A, and the image of the normal lung tissue captured using lasing emission-based detection, as illustrated in FIG. 5B, may be detected and captured simultaneously or consecutively. Further, in certain variations, the two images (i.e., FIGS. 5A and 5B) may be combined into a single image with different emission colors indicating the emission as fluorescence or lasing.

Similarly, the image of the cancerous lung tissue captured using fluorescence-based detection, as illustrated in FIG. 6A, and the image of the cancerous lung tissue captured using lasing emission-based detection, as illustrated in FIG. 6B, may be detected and captured simultaneously or consecutively. Further, in certain variations, the two images (i.e., FIGS. 6A and 6B) may be combined into a single image with different emission colors indicating the emission as fluorescence or lasing. Similar comparisons may be completed for FIGS. 5C-5D and/or 6C-6D.

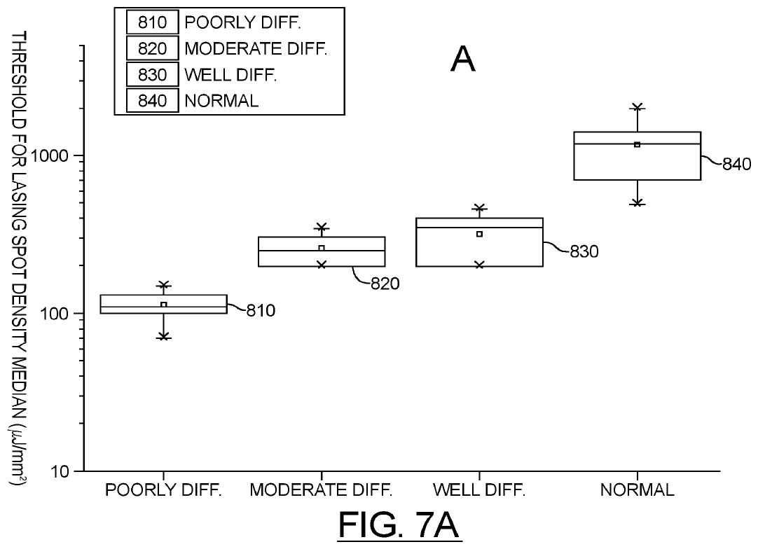

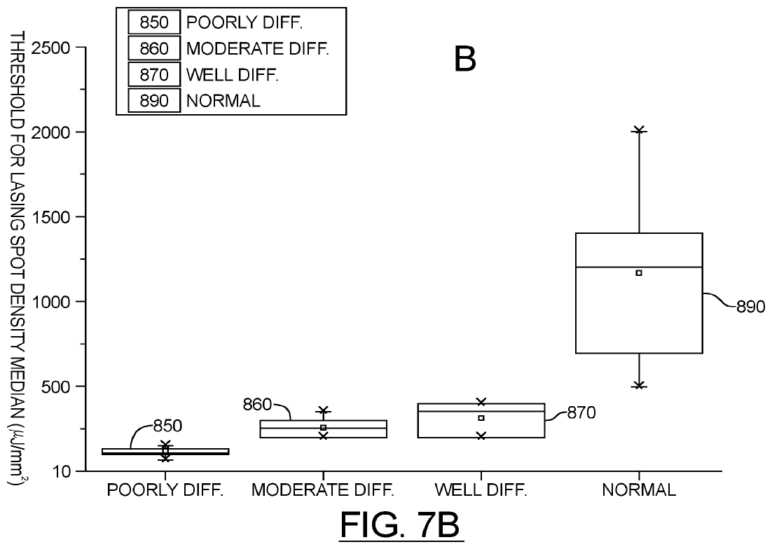

FIGS. 7A and 7B are graphical illustrations of pump thresholds for various levels of cell differentiations in a cancerous lung tissue. Pump thresholds refer to a minimum excitation powder needed to achieve non-zero median density of lasing spots per tissue sample (e.g., the normal lung tissue sample, the cancerous lung tissue sample). The illustration in FIG. 7A is in logarithmic scale. The illustration in FIG. 7B is in linear scale. As illustrated, the pump threshold is different for different levels of differentiated samples (e.g., cancerous lung tissues) and normal samples (e.g., normal lung tissues).

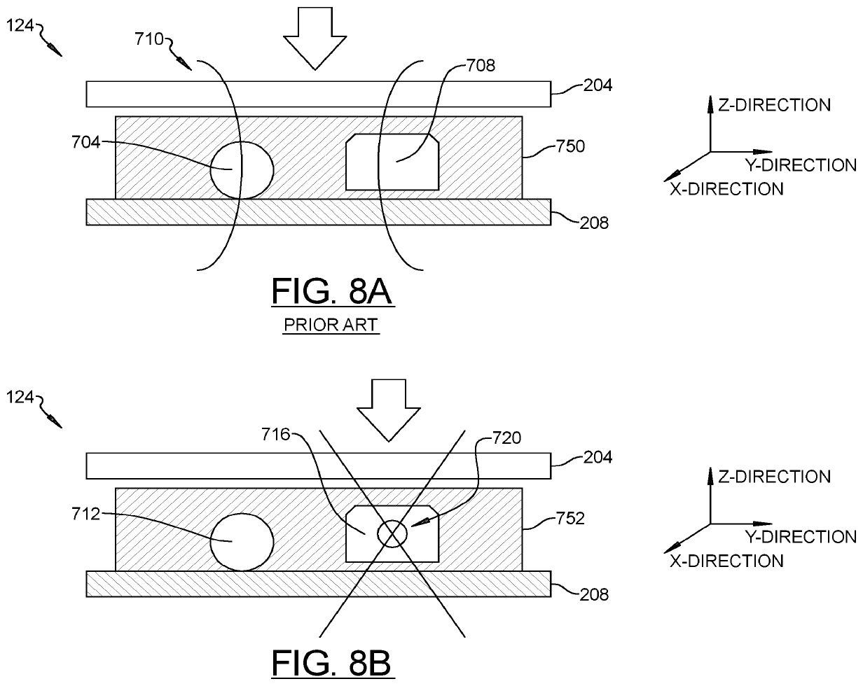

In another aspect of the present disclosure, the simultaneous detection imaging system 100 of FIG. 1 can direct the interrogating lasing beam (e.g., pulsed laser) that is illuminating or exciting a fluorophore of the dye to a specific location of the laser cavity 124 by using multiphoton excitation. Described with respect to FIG. 1, the simultaneous detection imaging system 100 can perform multiphoton excitation to detect a laser emission. For example, FIG. 8A is a diagram of regular single-photon excitation of the tissue sample 750 in the laser cavity 124, showing a side view of the laser cavity 124 including the top or first mirror 204 and the bottom or second mirror 208 (as introduced in FIG. 2). In standard single-photon excitation, the excitation light source 128 excites a single photon within an excitation volume 710, which is then absorbed by dye molecules 704 and 708 within the excitation volume 710. The dye molecules 704 and 708 emit a photon, which (by definition) is weaker than the absorbed photon, and the simultaneous detection imaging system 100 detects the lasing and fluorescence emission reflected from the tissue sample 750. However, single-photon excitation, as shown by the excitation volume 710, generally excites an area of the laser cavity 124 and is not narrowly directed to a specific location of the laser cavity 124. That is, since the excitation volume 710 is a large area, the simultaneous detection imaging system 100 is unable to discover information about a specific x-y location of dye molecules along the z-direction. In addition, the image resolution in the x-y plane is low.

FIG. 8B is a diagram of multiphoton excitation of a tissue sample 752 treated with dye in the laser cavity 124, showing a side view of the laser cavity 124 including the top or first mirror 204 and the bottom or second mirror 208 (as introduced in FIG. 2). The tissue sample 752 is placed in the laser cavity 124 between the first mirror 204 and the second mirror 208. The tissue sample 752 includes dye molecules 712 and 716. As shown in FIG. 8B, multiphoton excitation occurs when the excitation light source 128 directs an excitation volume 720 at a specific location x, y, and z in the laser cavity 124. The excitation volume 720 excites multiple photons and one dye molecule (for example, dye molecule 716) absorbs the multiple excited photons, in most cases two or three photons.

In this way, the photon emitted from the dye molecule 716 that absorbs the multiple photons (i.e., the laser emission) is stronger than single-photon excitation due to the multiphoton excitation and absorption. Further, the excitation volume 720 provides the ability to penetrate the laser cavity 124 at greater depths along the z-axis as well as more specific locations along the z-axis. In other words, multiphoton excitation provides the ability to direct the excitation light source 128 at a specific location of the laser cavity 124 and penetrate the laser cavity 124 at varying depths along the z-axis to excite multiple photons for absorption at specific locations in the laser cavity 124 to generate the laser emission, which has not previously been possible. To excite multiple photons, the excitation light source 128 is a high powered, pulsed laser with a high spatial and temporal density of photons to have two (or more) photons reach the specific location in the laser cavity 124 at the same time.

While FIG. 8B shows a single dye molecule being excited, dye molecule 716, in practice, only a small portion of the dye molecules in the z-direction are excited at the x and y location of the laser cavity 124 as a result of the small excitation volume 720. By adjusting the excitation volume 720 or excitation location, the dye distribution along the z-direction can be mapped at the x and y location. In addition, due to the smaller excitation area in the x-y plane, the image resolution using multiphoton excitation is higher than using single-photon excitation. That is, the simultaneous detection imaging system 100 of FIG. 1 can excite a specific x, y, z location within the laser cavity to excite a small portion of dye molecules at the location. The simultaneous detection imaging system 100 is further configured to perform multiphoton excitation at each location within the laser cavity (in the x, y, and z directions) to detect the laser emission of the small portion of dye molecules at each location.

In combination, the simultaneous detection imaging system 100 can excite a specific location within the laser cavity while detecting both fluorescence and laser emissions of the small portion of dye molecules at the specific location. In an example embodiment, the controller 104 includes location information that relate each location in the laser cavity 124 to a position of the motorized stage 120.

In this way, the controller 104 can automatically adjust the position of the motorized stage 120 to capture or detect the lasing and fluorescence emission at each location (small portion of dye molecules) within the laser cavity 124. That is, the controller 104 is configured to automatically move the motorized stage 120 so that the excitation light source 128 is directed at each location in the laser cavity 124. The controller 104 iterates through each location, moving the motorized stage 120 and detecting the laser emission at each location. The motorized stage 120 may also be manually moved via user input through the controller 104. The location information to instruct where to move the motorized stage 120 to can be stored on a memory associated with the controller 104. Further, in the automatic implementation described above, the controller 104 instructs the storing of the detected emissions for each location to map the emissions of the entire tissue sample in the laser cavity 124. Additional information describing the single and multiphoton excitation are described in Zipfel, W. R., Williams, R. M., & Webb, W. W., Nonlinear magic: multiphoton microscopy in the biosciences, Nature Biotechnology (2003) and Ustione, A. & Piston, D. W., A simple introduction to multiphoton microscopy, Journal of Microscopy (2011), the disclosures of which is hereby incorporated by reference in their entirety.

In certain variations, the present disclosure provides method for capturing both a laser emission at a first spectral band and a fluorescence emission at a second spectral band from a sample. The may include adding a dye (such as, YO-PRO® or fluorescein isothiocyanate (FITC)) to a tissue sample and disposing the tissue sample including the die in a laser cavity, such as detailed above. In certain variations, the method may include obtaining the tissue sample.

The techniques described herein or portions thereof may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An imaging system comprising:
a laser cavity configured to receive a biological sample, the biological sample is treated with a dye;
an excitation light source configured to direct energy at the laser cavity causing an emission from the biological sample, the emission including a laser emission at a first spectral band and a fluorescence emission at a second spectral band;
a first detector configured to measure the laser emission generated by the biological sample;
a second detector configured to measure the fluorescence emission generated by the biological sample;
a splitter configured to direct the laser emission to the first detector and the fluorescence emission to the second detector; and
a controller interfaced with the excitation light source, the first detector, and the second detector.

2. The imaging system of claim 1, wherein the laser cavity is defined by a first mirror and a second mirror and the biological sample is disposed between the first mirror and the second mirror.

3. The imaging system of claim 2, wherein the first mirror is arranged parallel to the second mirror.

4. The imaging system of claim 2, wherein a reflectivity of the first mirror is greater than a first threshold so as to detect the laser emission, and
wherein a transmission of the first mirror is above a second threshold so as to detect the fluorescence emission.

5. The imaging system of claim 1, wherein the splitter is a dichroic mirror configured to separate the fluorescence emission and the laser emission included in the emission from the biological sample.

6. The imaging system of claim 1, wherein the first spectral band is between about 524 nm and about 570 nm, and the second spectral band is greater than about 590 nm.

7. The imaging system of claim 1, wherein the excitation light source is configured to perform at least one of single-photon excitation and multi-photon excitation.

8. The imaging system of claim 1, further comprising:
a motorized stage, wherein the laser cavity is disposed on the motorized stage.

9. The imaging system of claim 8, wherein the controller further interfaces with the motorized stage and the controller is configured to adjust a position of the laser cavity relative to the excitation light source using the motorized stage.

10. The imaging system of claim 9, wherein the controller is configured to align a first location of the laser cavity with the excitation light source, and subsequently, to align a second location of the laser cavity with the excitation light source.

11. The imaging system of claim 1, wherein the splitter is a first splitter and the imaging system further comprises:
at least one of a beam expansion lens set, a mirror, a mirror scanning system, a scanning lens set, a second splitter, and an objective lens configured to direct the energy at the laser cavity.

12. The imaging system of claim 1, wherein the splitter is a first splitter and the imaging system further comprises:
at least one of a second splitter, a tube lens, and an objective lends configured to direct the emission to the first splitter.

13. An imaging system comprising:
a motorized stage;
a laser cavity disposed on the motorized stage and configured to receive a biological sample, the biological sample is treated with a dye;
an excitation light source configured to direct energy at the laser cavity causing an emission from the biological sample, the emission including a laser emission at a first spectral band, the excitation light source configured to cause at least one of single-photon excitation and multi-photon excitation;
a first detector configured to measure the laser emission generated by the biological sample; and
a controller interfaced with the excitation light source, the first detector, and the motorized stage, the controller is configured to:
adjust a position of the motorized stage based on a predetermined location within the laser cavity; and
direct the excitation light source to direct energy to the predetermined location within the laser cavity to perform single-photon excitation and multi-photon excitation.

14. The imaging system of claim 13, further comprising:
a second detector configured to measure a fluorescence emission at a second spectral band generated by the biological sample, wherein the emission includes the fluorescence emission, and the controller is further interfaced with the second detector.

15. The imaging system of claim 14, further comprising a beam splitter configured to receive the emission and direct the laser emission to the first detector and direct the fluorescence emission to the second detector.

16. The imaging system of claim 13, wherein the predetermined location within the laser cavity includes an x location, a y location, and a z location.

17. An imaging system comprising:
a motorized stage;
a laser cavity disposed on the motorized stage and configured to receive a biological sample, the laser cavity is defined by a first mirror and a second mirror and the biological sample is disposed between the first mirror and the second mirror, and the biological sample is treated with a dye;
an excitation light source configured to direct energy at the laser cavity causing an emission from the biological sample, the emission including a laser emission at a first spectral band and a fluorescence emission at a second spectral band, the excitation light source configured to cause at least one of single-photon excitation and multi-photon excitation;
a first detector configured to measure the laser emission generated by the biological sample;
a second detector configured to measure the fluorescence emission generated by the biological sample;
a beam splitter configured to direct the laser emission to the first detector and the fluorescence emission to the second detector; and
a controller interfaced with the excitation light source, the first detector, the second detector, and the motorized stage.

18. The imaging system of claim 17, wherein a reflectivity of the first mirror is greater than a first threshold so as to detect the laser emission, and
wherein a transmission of the first mirror is above a second threshold so as to detect the fluorescence emission.

19. The imaging system of claim 17, wherein the beam splitter is a dichroic mirror configured to separate the fluorescence emission and the laser emission included in the emission from the biological sample.

20. The imaging system of claim 17, wherein the controller is configured to:
adjust a position of the motorized stage based on a predetermined location within the laser cavity; and
direct the excitation light source to direct energy to the predetermined location within the laser cavity to perform single-photon excitation and multi-photon excitation.
